(19) United States
(12) Patent Application Publication
(10) Pub. No.: US 2007/0143536 A1
(43) Pub. Date: Jun. 21, 2007

(54) Storage device that pre-fetches data responsive to host access stream awareness

(75) Inventors: Jasbir Sidhu, San Jose, CA (US); Andrew Vogan, Portland, OR (US)

Correspondence Address: David K. Purks;Myers Bigel Sibley & Sajovec, P.A., P.O. Box 37428, Raleigh, NC, 27627, US

(73) Assignee: Maxtor Corporation

(21) Appl. No.: 11/353,274

(22) Filed: Feb. 13, 2006

Related U.S. Application Data
(60) Provisional application No. 60/687,932, filed on Jun. 7, 2005.

(51) Int. Cl. G06F 12/00

(52) U.S. Cl. 711/112

(57) ABSTRACT

A data storage device includes a data storage media, a head, a data fetch buffer, and a controller. The head is configured to read data stored in logical block addresses (LBA) on the media. The data fetch buffer is configured to store data. The controller is configured to read data through the head from LBAs on the media that are identified by LBA access sequence information in the data storage device which identifies a sequence of LBAs that a host device will access and to store the read data in the data fetch buffer. The controller is also configured to respond to a read command from the host device that is directed to data at a LBA of the media that is identified the LBA access sequence information and which has been read into the data fetch buffer by communicating the data associated with the read command from the data fetch buffer to the host device.

### RELATED APPLICATION

This application claims the benefit of and priority to U.S. Provisional Patent Application No. 60/687,932, filed Jun. 7, 2005, the disclosure of which is hereby incorporated herein by reference as if set forth in its entirety.

### FIELD OF THE INVENTION

The present invention generally relates to data storage devices, host devices, and computer program products for accessing data streams, such as audio/video data streams.

### BACKGROUND OF THE INVENTION

Common types of data storage devices that are used with computers and data processing systems for storing information in digital form include disk drives (e.g., magnetic and/or optical) and tape drives. A conventional disk drive includes a head stack assembly, one or more data storage disks and a spindle motor that rotates the storage disks. The head stack assembly includes an actuator arm assembly that includes one or more read/write heads mounted to flexure arms. The actuator motor can rotate the flexure arms and heads about a pivot bearing to radially position the heads while writing data to or reading data from concentric data tracks on the disks.

In response to a read/write command from a host device for a disk drive to read/write data on a target block, the disk drive must position a head over the target block along a target track before it can read/write the data. Through a seek operation, the disk drive moves the head radially across data tracks from a starting track to the destination track. Thereafter, the rotation of the disks moves the target block of the destination track under the head so that the data can be read therefrom or written thereto. The amount of time required for accessing the target block, or access time, includes the cumulative time for the seek operation to position the head over the destination track, the time for the head to settle onto the destination track, and a rotational latency which is the time for the target block on the destination track to rotate under the head. Accordingly, the elapsed time that it takes for a disk drive to execute a read/write host command depends in part on the access time.

Disk drives can move the heads during seek operations using velocity profiles that are primarily designed to minimize access time while attempting accommodate constraints that may be imposed on the generation of acoustical noise induced by the seek operations, heat generation, and/or data error avoidance/recovery (data integrity). Some disk drives reshuffle queued read/write host commands in an attempt to decrease the cumulative time needed to access several blocks of data in relatively adjacent tracks. However, the velocity profiles and/or reshuffling processes are typically designed with an expectation that the disk drives will be used with personal computer systems where the read/write commands generally cause random seek operations. The velocity profiles and/or reshuffling processes may not provide acceptable access times, acoustical noise, thermal management, and/or data integrity when the disk drives are used with hosts that cause substantially non-random seek operations such when reading Audio/Video (AV) data streams.

Disk drives are increasingly being utilized for storage of AV content in AV systems, high-definition and other high resolution AV contents streams, interactive TV gaming, broadband Internet AV services, and AV surveillance, such as in consumer electronics. For example, Digital Video Recorders (DVRs) have entered the consumer electronics market which allow users to essentially time-shift selected broadcasts. Moreover, some DVRs allow simultaneous recording or more than one broadcast and/or simultaneous recording and playback of different broadcasts. Accordingly, a disk drive in an AV system should provide sufficient storage capacity to allow an acceptable amount of AV content to be stored, and should provide high data throughput because of the need to store/retrieve multiple AV data streams in real-time without perceptible interruptions. Obtaining a sufficiently high data throughput from a disk drive may be difficult where constraints on acoustical noise, thermal management, and/or data integrity are imposed.

### SUMMARY OF THE INVENTION

In some embodiments of the present invention, a data storage device includes a data storage media, a head, a data fetch buffer, and a controller. The head is configured to read data stored in logical block addresses (LBA) on the media. The data fetch buffer is configured to store data. The controller is configured to read data through the head from LBAs on the media that are identified by LBA access sequence information in the data storage device which identifies a sequence of LBAs that a host device will access and to store the read data in the data fetch buffer. The controller is also configured to respond to a read command from the host device that is directed to data at a LBA of the media that is identified the LBA access sequence information and which has been read into the data fetch buffer by communicating the data associated with the read command from the data fetch buffer to the host device.

Accordingly, the host device informs the data storage device of a sequence of LBAs that it plans to read data from. The data storage device prepares for the anticipated read commands from the host device by reading data from the identified sequence of LBAs into the data fetch buffer. In response to a read command from the host device that is directed to one of the LBAs in the sequence of LBAs, the corresponding data is communicated from the data fetch buffer to the host device. The data storage device may be configured to use the additional time between being informed by the host device of the LBA sequence and receipt of read commands directed to those LBAs to read the data in a manner that satisfies constraints on peak and/or average data throughput, acoustical noise that can be generated, heat generation, peak and/or average power consumption, and/or data integrity.

In some embodiments of the present invention, the data storage device is a disk drive. The data storage media includes a rotatable data storage disk, and the head is configured to read data storage in LBAs on the disk.

Some other embodiments of the present invention provide a computer program product for reading data storage locations on a data storage media in a data storage device. The computer program product includes computer program code that is embodied in a computer-readable storage medium. The computer program code is configured to be executed by a host device to define a sequence of logical block addresses (LBAs) of data storage locations on the media in the data storage device that the host device will access. Other computer program code is configured to be executed by the host device to communicate the defined sequence of LBAs as LBA access sequence information from the host device to the data storage device. Yet other computer program code is configured to be executed by the host device to communicate a read command to the data storage device to read data from a LBA identified by the LBA access sequence information after communicating the LBA access sequence information to the data storage device.

Some other embodiments of the present invention are directed to corresponding methods for a host device to read data storage locations on a data storage media in a data storage device. These and other embodiments of the present invention are explained below with reference to the following drawings.

### DESCRIPTION OF THE DRAWINGS

FIG. 1 is a perspective view of a disk drive with electronic circuits that are configured in accordance with some embodiments of the present invention.

FIG. 2 is a block diagram of a disk stack having a plurality of data storage disks.

FIG. 3 is a perspective view of a portion of an actuator arm assembly having a plurality of actuator arms.

FIG. 4 is a block diagram of a portion of the electronic circuits of the disk drive shown in FIG. 1 that are configured in accordance with some embodiments of the present invention.

FIG. 5 is a block diagram of a host device that is configured in accordance with some embodiments of the present invention.

FIG. 6 is a flowchart of operations that may be carried out by the host device of FIG. 5 to generate LBA access sequence information and to communicate that information to the disk drive of FIG. 1 before sending associated read commands, in accordance with some embodiments of the present invention.

FIG. 7 is a flowchart of operations that may be carried out by the disk drive of FIG. 1 to respond to LBA access sequence information and associated read commands from the host device of FIG. 5 in accordance with some embodiments of the present invention.

### DETAILED DESCRIPTION OF EMBODIMENTS OF THE INVENTION

The present invention now will be described more fully hereinafter with reference to the accompanying drawings, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the figures and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. As used herein the terms “and/or” and “/” include any and all combinations of one or more of the associated listed items. It will be understood that, although the terms first, second, etc. may be used herein to describe various elements and/or regions, these elements and/or regions should not be limited by these terms. These terms are only used to distinguish one element/region from another element/region. Thus, a first element/region discussed below could be termed a second element/region without departing from the teachings of the present invention.

The present invention may be embodied as apparatus, methods, and/or computer program products. Accordingly, the present invention may be embodied in hardware and/or in software (including firmware, resident software, micro-code, etc.). Consequently, as used herein, the term “signal” may take the form of a continuous waveform and/or discrete value(s), such as digital value(s) in a memory. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution computer system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disk read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The functions/acts noted in the blocks of the block diagrams may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Exemplary embodiments of the present invention are described below with regard to a magnetic disk drive and an associated host device for purposes of explanation. However, it is to be understood that the present invention in not limited to use with disk drives and that, instead, it can be used with any type of data storage device, including, but not limited to, optical disk drives (e.g., CD-R/W, DVD-R/W) and tape drives. Accordingly, as used herein, “data storage media” refers to any media that is configured to store data and includes, but is not limited to, a magnetic disk, an optical disk, and magnetic tape. Also as used herein, “head” refers to any device that is configured to read and write data on a data storage media.

A simplified diagrammatic representation of a disk drive, generally designated as 10, is illustrated in FIG. 1. The disk drive 10 includes one or more disks arranged in a disk stack 12 that is rotated by a spindle motor 14. The spindle motor 14 is mounted to a base plate 16. An actuator arm assembly 18 is also mounted to the base plate 16. The disk drive 10 is configured to store and retrieve data responsive to read and write commands from a host device. A host device can include, but is not limited to, a desktop computer, a laptop computer, a personal digital assistant (PDA), a digital video recorder/player, a digital music recorder/player, and/or another electronic device that can be communicatively coupled to the disk drive 10 to store and retrieve data.

The actuator arm assembly 18 includes a head 20 (or transducer) mounted to a flexure arm 22 which is attached to an actuator arm 24 that can rotate about a pivot bearing assembly 26. The head 20 may, for example, comprise an magnetoresistive (MR) element and/or a thin film inductive (TFI) element. An actuator motor 28 (e.g., a voice coil motor (VCM)) rotates the actuator arm assembly 18 to radially move the head 20 relative to the disk stack 12. The spindle motor 14 and actuator arm assembly 18 are coupled to a controller, read/write channel circuits, and other associated electronic circuits 30 which can be enclosed within one or more integrated circuit packages mounted to a printed circuit board (PCB) 32. The electronic circuits 30 may include analog and/or digital circuitry, and typically include a digital signal processor (DSP), a microprocessor-based controller, and memory devices. The electronic circuits 30 can be configured accordingly to various embodiments of the present invention as will be explained further below.

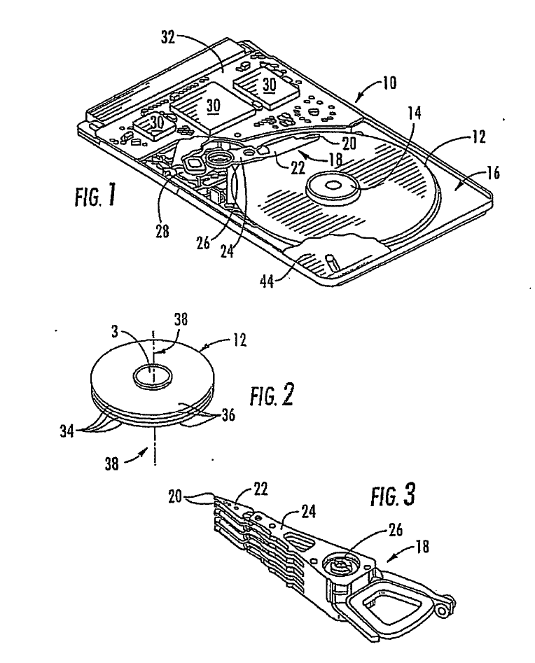

Referring now to the illustration of FIG. 2, the disk stack 12 typically includes a plurality of disks 34, each of which may have a pair of disk surfaces 36, 36. The disks 34 are mounted on a cylindrical shaft and are configured to rotate about axis 38 via the spindle motor 14. Although the disks 34 are described as magnetic disks for purposes of illustration, they may alternatively be optical disks or any other type of data storage disk.

Referring now to the illustration of FIGS. 1 and 3, the actuator arm assembly 18 can include a plurality of the heads 20, each of which are adjacent to a different one of the disk surfaces 36. Each head 20 is mounted to a corresponding flexure arm 22 which is attached to a corresponding portion of the actuator arm 24 that can rotate about the pivot bearing assembly 26. The actuator motor 28 operates to move the actuator arm 24, and thus moves the heads 20 in a radial direction relative to their respective disk surfaces 36.

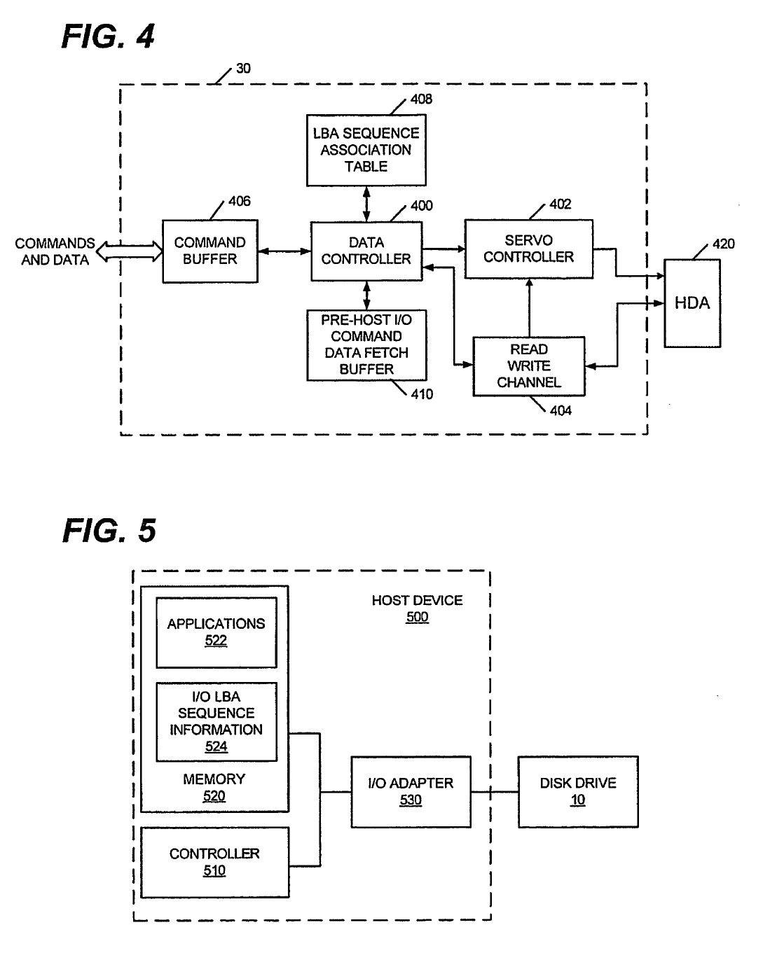

Referring to FIG. 4, the electronic circuits 30 can include a data controller 400, a servo controller 402, a read write channel 404, a host command buffer 406, a LBS sequence association table 408, and a pre-host input/output (I/O) command data fetch buffer 410. The exemplary embodiment of the electronic circuits 30 has been illustrated with two separate controllers 400,402, read write channel 404, and three separate memory devices 406, 408, and 410 for purposes of illustration and discussion only. It is to be understood that the functionality that is described herein for one or more of the controllers 400,402, the read write channel 404, and/or the devices 406,408,410 may be integrated within one integrated circuit package or distributed among more than one integrated circuit package. The head disk assembly (HDA) 420 may include the actuator arm assembly 18, the disk stack 12, the actuator motor 28, and the spindle motor 14.

The read write channel 404 can operate in a conventional manner to convert data between the digital form used by the data controller 400 and the analog form conducted through the heads 20 in the HDA 420. The read write channel 404 provides servo positional information read from disk 34 in the HDA 420 to the servo controller 402. The servo positional information can be used to detect the location of the head 20 in relation to logical block addresses (LBAs) along tracks on the disk 34. The servo controller 402 can use LBAs from the data controller 400 and the servo positional information to seek the head 20 to an LBA on a target track of one of the disk surfaces 36, and to maintain the head 20 aligned with the target track while data is written/read on the LBA.

Read and write commands from a host device can be temporarily buffered in the command buffer 406 while data associated with the commands waits to be read from or written to LBAs identified by the buffered host commands. The data controller 400 is configured to carry out a buffered write command by formatting the associated data into blocks with the appropriate header information, and to transfer the formatted data from the command buffer 406, via the read/write channel 404, to the LBA on the disk 34 that is identified by the buffered write command. Similarly, a buffered read command from the host device may be temporarily buffered in the command buffer 406 until data is retrieved from the LBA on the disk 34 that is identified by the buffered read command and communicated to the host device. Buffered commands can be separately removed from the command buffer 406 upon their respective completion.

Some embodiments of the present invention may arise from a recognition that some host devices, such as DVRs, digital video players, and other AV systems, can read data from sequences of LBAs that can be determined by the AV system in advance of it needing to read the data from a disk drive. For example, when an AV system is commanded to play a movie, it can be configured to determine an LBA sequence from which it will need to read data from the disk drive 10 to assemble at least a portion of the movie video frames. The AV system can therefore inform the disk drive 10 of at least a portion of a defined LBA sequence before it begins communicating read commands to the disk drive 10 to read data from those LBAs. Alternatively, or additionally, the disk drive 10 may observe and learn the LBA sequence access information over time so that it can anticipate what LBAs it will need to access responsive to receiving read commands to one or more LBAs identified by LBA access sequence information and/or to other LBAs associated with those identified by LBA access sequence information (e.g., receiving read commands to LBAs containing video frame data that precedes video frame data identified by LBAs identified by LBA access sequence information). The disk drive 10 can begin fetching data from LBAs identified by LBA access sequence information to prepare for receipt of associated read commands from the AV system.

Because at least some of the data from the LBA access sequence may be fetched in advance of receipt of associated read commands, the disk drive 10 may be configured to use the additional time between receipt of the LBA access sequence information and receipt of read commands directed to LBAs identified by the LBA access sequence information to carry out the read operations in a manner that satisfies constraints on peak and/or average data throughput, acoustical noise that can be generated, heat generation, peak and/or average power consumption, and/or data integrity. For example, the disk drive 10 may use this additional time to rearrange the order in which it carries out the LBS access sequence, such as to access the LBAs in a way that minimizes seek time between accesses (e.g., reorder sequence to access LBAs in an increasing/decreasing numerical order).

In accordance with some embodiments of the invention, the data controller 400 is configured to store information for one or more LBA access sequences in the LBA sequence association table 408. The LBA access sequence information may be defined by a host device and communicated to the disk drive 10. In response to receiving the LBA access sequence information from the host device, the disk drive 10 can begin reading data from the disk LBAs, which are identified by the LBA access sequence information, into the fetch buffer 410. When a host read command is received that is directed to data from one or more LBAs that has been retrieved to the fetch buffer 410, the data can be moved from the fetch buffer 410 to the command buffer 406 and communicated to the host device responsive to the read command. Because the LBA access sequence information provides an early notice to the disk drive 10 of what LBAs will be subsequently accessed by the host device, the data controller 400 can be further configured to manage its fetching from disk LBAs identified by the LBA access sequence information so as to satisfy constraints on peak and/or average data throughput, acoustical noise, heat that can be generated by one or more components of the disk drive 10, peak and/or average power consumption by the disk drive 10, and/or data error recovery processes. For example, the data controller 400 may cause the servo controller 402 to carry out seek operations to read data using a velocity profile that causes less acceleration/deceleration of the actuator arm assembly 18 (so as to reduce noise, heat, and/or power consumption) and/or using more robust error recovery processes, such as by carrying out more re-read attempts from the disks 34 to correct data errors upon their detection, than may otherwise be used by the data controller 400 and/or servo controller 402 when responding within time constraints of host read commands.

In some embodiments, the LBA access sequence information in the table 408 may define groups of contiguous disk LBAs and the relative order in which the groups are expected to be accessed by the host device. For example, the table 408 may define a sequence of groups of one or more LBAs, where each of the groups may define a start LBA, a number of LBAs that contiguously follow the start LBA within the group, and a type of I/O access associated with the start LBA (e.g., LBSs will be sequentially accessed in the groups, LBAs will be accessed by jumping a defined numbers of LBAs between each access). For example, a host may communicate sequence access information to the disk drive 10 that identifies that it will read a movie segment starting at LBA 10, continue reading the next 90 LBAs, jump 50 LBAs, read next 100 LBAs, jump 250 LBAs, read next 200 LBAs, jump 4300 LBAs, and read next 4000 LBAs (corresponding to reading LBAs 10-100, 150-250, 500-700, 5000-9000).

An exemplary host device 500 is illustrated by the block diagram of FIG. 5. The host device 500 includes a controller 510, a memory 520 that includes applications 522 and I/O LBA sequence information 524, and an I/O adapter 530. The I/O adapter 530 can be configured to communicatively couple the host device 500 to the disk drive 10 through, for example, a ATA bus, SATA bus, small computer system interconnect (SCSI) bus, firewire bus, and/or a universal serial bus (USB). The controller 510 can be configured by the applications 522 to, for example, function as an AV system that retrievably stores AV content, such as from broadcast media sources (e.g., satellite, terrestrial, cable, and/or Internet TV sources), interactive TV gaming, broadband Internet AV services, and/or AV surveillance on the disk drive 10.

The controller 510 may be further configured to support simultaneous storing and/or retrieving of a plurality of AV content data streams to/from the disk drive 10. The controller 510 is configured to define an LBA sequence that it will be accessing, such as to play a movie. It may define the LBA sequence by reading a file (link) table from the disk drive 10 which identifies the disk LBAs where file data is stored. It then sends the defined LBA sequence as LBA access sequence information back to the disk drive 10, such as by adding information to the file table and writing the file table back to the disk drive 10, before it begins sending read commands to the disk drive 10 that are directed to LBAs identified by the LBA access sequence information. Accordingly, as described above, the disk drive 10 may fetch data from the identified disk LBAs to the fetch buffer 410 in preparation for receiving imminent host read commands directed to the identified LBAs. The controller 510 may communicate the LBA access sequence information to the disk drive 10 a defined amount of time before it sends read/write commands directed to those LBAs to allow the disk drive 10 sufficient time to fetch at least some, or all, of the data identified by the LBAs to the fetch buffer 410. The amount of time between when the controller 510 communicates the LBA access sequence information to the disk drive 10 and when it begins reading from the identified LBAs may be selected based on the amount of data that can be stored in the fetch buffer 410. For example, the time may be selected to allow the disk drive 10 several seconds (e.g., 2-5 seconds) or up to several minutes between receiving the sequence information and receiving read commands thereto.

By way of an exemplary embodiment with reference to FIGS. 4 and 5, the host device 500 may be DVR. An end-user may command the host device 500 to begin playing a movie that is recorded on the disk drive 10. The controller 510 can read a file table from the disk drive 10 and generate based thereon a first LBA access sequence that indicates what LBAs the host device 500 will be reading data from to generate AV frames for the movie. The controller 510 may store the first LBA access sequence in the memory 520 as part of the LBA access sequence information 524 where it can be associated with at least a segment of the movie for later use if that movie segment is replayed. The controller 510 communicates the first LBA access sequence through the I/O adapter 530 to the disk drive 10. The data controller 400 stores the first LBA access sequence in the table 408, fetches data from the disk LBAs identified by the first LBA access sequence into the data fetch buffer 410, and, in response to individual read commands from the host device 500 it copies the associated data from the data fetch buffer 410 to the command buffer 406 and communicates the data to the host controller 510, such as in accordance with embodiments explained above. The host controller 510 assembles AV frame(s) based on the data and communicates further read commands to the disk drive 10 that are directed to LBAs in the first LBA access sequence. The host controller 510 can generate and communicate further LBA access sequences to the disk drive 10 to cause the disk drive 10 to prepare for further read commands as the host device 500 assembles subsequent data streams for use in generating subsequent AV frames of the movie.

While the host device 500 is playing the movie, an end-user may command it to begin playing another movie. The controller 510 can read the file table from the disk drive 10 and generate a second LBA access sequence that identifies the LBAs at which at least a portion of the movie data will be read. The controller 510 communicates the second LBA access sequence through the I/O adapter 530 to the disk drive 10. The data controller 400 stores the second LBA access sequence in the table 408 and reads data from the identified LBAs into the data fetch buffer 410. The data controller 400 may additionally, or alternatively, use LBAs identified by the second LBA access sequence to reorder and prioritize read operations that are associated with fetching data identified by the first LBA access sequence and/or the second LBA access sequence in an attempt to satisfy data throughput demands, acoustical noise constraints, heat generation constraints, power consumption constraints, and/or data error recovery process constraints.

As explained above, in some of the embodiments of the present invention, a host device defines the LBA sequence that it will be accessing and communicates that sequence to the disk drive 10. According to some other embodiments, the disk drive 10 can be configured to determine the LBA access sequence itself. For example, the data controller 400 can be configured to observe and learn patterns of LBAs that are retrieved in sequence, and can record the learned LBA sequences in the table 408. The data controller 400 may, for example, record LBA sequences for read commands that appear to be related to reading of a data stream (e.g., playing back an AV data stream). The data controller 400 may then determine when a buffered read command from a host device is related to a LBA access sequence defined in the table 408 by, for example, determining when the targeted LBA of the buffered read command is within the defined LBA access sequence or when the targeted LBA has been observed to be accessed close in time prior to accessing data in the defined LBA access sequence. In response to determining that a buffered read command is related to the defined LBA access sequence, the data controller 400 can fetch data from the defined LBA access sequence into the fetch buffer 410 in preparation for subsequent host commands for data therefrom, such as was explained above.

In some further embodiments, the host 500 may be configured to include in the LBA access sequence information a defined data transfer rate at which it will command the disk drive 10 to read from the identified LBAs through a sequence of host read commands. Alternatively, or additionally, the disk drive 10, via the controller 400, may be configured to observe and define therefrom the data transfer rate associated with LBA access sequences in table 408. The controller 400 may then use the known data transfer rate to adjust how it reads data from the associated LBA sequence(s). For example, a first LBA sequence associated with a regular-definition movie may have a defined/learned data transfer rate of 7 MBits/Sec, while a second LBA sequence associated with a high-definition movie may have a defined/learned data transfer rate of 19 MBits/Sec. Based on these known data transfer rates, the controller 400 may read more data from the second LBA sequence in the data fetch buffer 410 further in advance of receiving associated read commands thereto than it does for the first LBA sequence. Accordingly, the controller 400 may thereby adapt to known data transfer rates of LBA sequences by varying how much data it reads into the buffer 410 in advance of associated host read commands.

The fetch buffer 410 may include an integrated circuit memory, such as, for example, a dynamic random access memory (DRAM) and/or static RAM. However, in other some embodiments, the fetch buffer 410 may include a temporary storage location on the disks 34. For example, the data controller 400 may copy data from disk LBAs identified by the LBA access sequence to the temporary storage location on the disks 34 in preparation for subsequent read commands from a host device. The temporary storage location may include contiguous disk LBAs. Accordingly, although the LBA access sequence may correspond to non-contiguous LBAs on the disks 34, and which may be widely dispersed across the disks 34, the addressed data may be copied to contiguous LBAs at the temporary storage location on the disks 34. The data controller 400 may then subsequently read back the data from the contiguous LBAs, in response to host read commands, more quickly than may be possible if the data were instead read from their original non-contiguous LBAs where delay associated with seek operations between distant tracks and LBAs thereon may result.

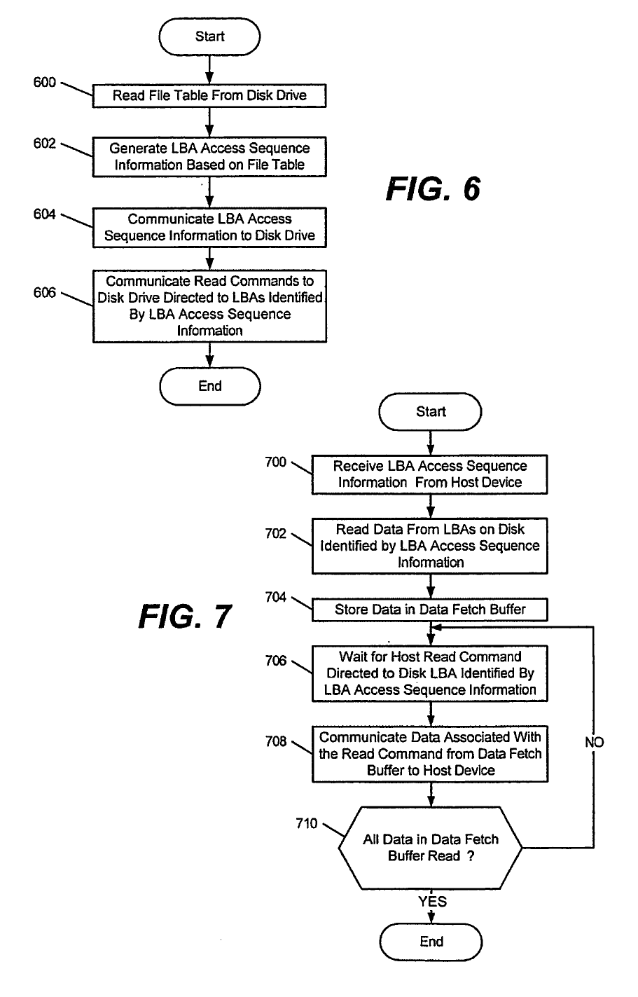

FIG. 6 is a flowchart of operations that may be carried out by the host device 500 to generate LBA access sequence information and to communicate that information to the disk drive 10 before sending associated read commands directed to LBAs identified by the LBA access sequence information, in accordance with some embodiments of the present invention. The host device 500 reads (Block 600) a file table from the disk drive 10. It then generates (Block 602) LBA access sequence information based on the file table. The host device 500 communicates the LBA access sequence information to the disk drive 10 (Block 604), and subsequently communicates read commands to the disk drive 10 (Block 606) that are directed to LBAs identified by the LBA access sequence information.

FIG. 7 is a flowchart of operations that may be carried out by the disk drive 10 to respond to LBA access sequence information and associated read commands from the host device 500 in accordance with some embodiments of the present invention. LBA access sequence information is received (Block 700) by the disk drive 10 from the host device 500. The disk drive 10 reads data (Block 702) from LBAs on the disks 34 which are identified by the LBA access sequence information. The data is stored (Block 704) in the data fetch buffer 410. In response to receipt of a host read command directed to data at a disk LBA identified by the LBA access sequence information (Block 706), the disk drive 10 communicates the data associated with the read command from the data fetch buffer 410 to the host device 500 (Block 708). A decision is then made (Block 710) as to whether all data identified by the LBA access sequence information has been read by the host device 500, and if not operations may loop back to Block 706 to await further host read commands and/or expiration of a refresh timer.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A data storage device comprising:
a data storage media;
a head that is configured to read data stored in logical block addresses (LBAs) on the data storage media;
a data fetch buffer that is configured to store data; and
a controller that is configured to read data through the head from LBAs on the data storage media that are identified by LBA access sequence information in the data storage device which identifies a sequence of LBAs that a host device will access and to store the read data in the data fetch buffer, and to respond to a read command from the host device that is directed to data at a LBA of the data storage media that is identified by the LBA access sequence information and which has been read into the data fetch buffer by communicating the data associated with the read command from the data fetch buffer to the host device.

2. The data storage device of claim 1, wherein:
the data storage media comprises a rotatable data storage disk;
the head is configured to read data stored in LBAs on the disk; and
the controller is configured to read data through the head from LBAs on the disk that are identified by LBA access sequence information in the data storage device which identifies a sequence of LBAs that the host device will access and to store the read data in the data fetch buffer, and to respond to a read command from the host device that is directed to data at a LBA of the disk that is identified the LBA access sequence information and which has been read into the data fetch buffer by communicating the data associated with the read command from the data fetch buffer to the host device.

3. The data storage device of claim 2, wherein the controller is configured to constrain acceleration and deceleration of the head to lower values during seeking operations when reading data from the disk responsive to the LBA access sequence information compared to when reading data from the disk responsive to read commands received from the host device.

4. The data storage device of claim 1, wherein the controller is configured to reorder the LBAs identified by the LBA access sequence information to carry out accesses to the identified LBAs in increasing or decreasing numerical order.

5. The data storage device of claim 1, wherein the controller is configured to prioritize among reading of data from each of the media LBAs identified by the LBA access sequence information into the data fetch buffer so as to increase throughput at which the data can be read from the media LBAs identified by the LBA access sequence information.

6. The data storage device of claim 1, wherein the controller is configured to prioritize among reading of data from each of the media LBAs identified by the LBA access sequence information into the data fetch buffer so as to reduce noise generated by the data storage device while reading data from the media LBAs identified by the LBA access sequence information.

7. The data storage device of claim 1, wherein the controller is configured to prioritize among reading of data from each of the media LBAs identified by the LBA access sequence information into the data fetch buffer so as to reduce power consumption by the data storage device while reading data from the media LBAs identified by the LBA access sequence information.

8. The data storage device of claim 1, wherein the LBA access sequence information identifies an order in which a sequence of LBAs on the media will be accessed by the host device.

9. The data storage device of claim 1, wherein the LBA access sequence information identifies LBAs on the media that are predicted to be accessed by the host device but does not identify a relative order by which each of the LBAs is predicted to be accessed by the host device.

10. The data storage device of claim 1, wherein the controller is configured to receive the LBA access sequence information from the host device, to store the LBA access sequence information within the data storage device, and to respond to receipt of the LBA access sequence information by reading data from media LBAs that are identified by the LBA access sequence information and to store the read data into the data fetch buffer.

11. The data storage device of claim 10, wherein the controller is configured to receive a plurality of different LBA access sequence information, to store the plurality of different LBA access sequence information in a table within the data storage device, to respond to receipt of each of the LBA access sequence information by reading data from media LBAs that are identified by each of the plurality of LBA access sequence information into the data fetch buffer, to identify when a read command from the host device is directed to data at a media LBA that is identified by one of the plurality of LBA access sequence information that has been read into the data fetch buffer by communicating the data associated with the read command from the data fetch buffer to the host device.

12. The data storage device of claim 1, wherein the controller is configured to read data from each LBA on the media identified by the LBA access sequence information into the data fetch buffer, and to respond to a sequence of read commands from the host device directed to data at LBAs identified by the LBA access sequence information that has been read into the data fetch buffer by communicating the associated data sequence from the data fetch buffer to the host device.

13. The data storage device of claim 1, wherein the controller is configured to observe patterns of LBAs that are read on the media by the host device, to generate the LBA access sequence information based on the observed patterns of read LBAs, to determine when a read command received from the host device indicates that further read commands from the host device are imminent which will be directed to media LBAs identified the LBA access sequence information, and to respond to the indication of imminent host read commands to media LBAs identified by the LBA access sequence information by reading data from media LBAs identified by the LBA access sequence information and to store the read data into the data fetch buffer.

14. The data storage device of claim 13, wherein the controller is configure to determine that a read command received from the host device indicates that read commands from the host device will subsequently be received which are directed to media LBAs identified by the LBA access sequence information when the read command received from the host is directed to a LBA that was previously observed by the controller to have been accessed by the host device close in time prior to access of LBAs identified by the LBA access sequence information.

15. The data storage device of claim 13, wherein the controller is configure to determine that a read command received from the host device indicates that read commands from the host device will subsequently be received which are directed to media LBAs identified the LBA access sequence information when the read/write command received from the host is directed to a LBA identified by the LBA access sequence information.

16. The data storage device of claim 1, wherein the data fetch buffer comprises a temporary storage location on the media, and the controller is configured to store the data read from LBAs identified by LBA access sequence information into the temporary storage location on the media.

17. The data storage device of claim 16, wherein the controller is configured to store the data read from LBAs identified by LBA access sequence information into a contiguous group of LBAs at the temporary storage location on the media.

18. The data storage device of claim 1, wherein the controller is configured to adjust how it reads data from LBAs identified by the LBA access sequence information based on a defined data transfer rate at which the host device will command the controller to read data from the LBAs identified by the LBA access sequence information.

19. The data storage device of claim 1, wherein the controller is configured to receive the defined data transfer rate with the LBA access sequence information from the host device.

20. A computer program product for reading data storage locations on a data storage media in a data storage device, the computer program product comprising computer program code embodied in a computer-readable storage medium, the computer program code comprising:
computer program code that is configured to be executed by a host device to define a sequence of logical block addresses (LBAs) of data storage locations on the media in the data storage device that the host device will access;
computer program code that is configured to be executed by the host device to communicate the defined sequence of LBAs as LBA access sequence information from the host device to the data storage device; and
computer program code that is configured to be executed by the host device to communicate a read command to the data storage device to read data from a LBA identified by the LBA access sequence information after communicating the LBA access sequence information to the data storage device.

21. The computer program product of claim 20, wherein the computer program code that is configured to communicate a read command to the data storage device to read data from a LBA identified by the LBA access sequence information after communicating the LBA access sequence information to the data storage device is further configured to communicate the LBA access sequence information at least a defined amount of time before it communicates the read command, wherein the amount of time is defined to be sufficient for the data storage device to read data from media LBAs identified by the LBA access sequence information to a fetch buffer in the data storage device.

22. The computer program product of claim 20, further comprising computer program code that is configured to reorder the LBAs identified by the LBA access sequence information to carry out accesses to the identified LBAs in increasing or decreasing numerical order.

23. The computer program product of claim 20, further comprising computer program code that is configured to be executed by the host device to read a file table from the data storage device that identifies on what media LBAs data is stored, and to generate based on the file table the LBA access sequence information that is communicated to the data storage device.

24. A method for a host device to read data storage locations on a data storage media in a data storage device, the method comprising:
defining a sequence of logical block addresses (LBAs) of data storage locations on the media in the data storage device from which the host device will read data;
communicating the defined sequence of LBAs as LBA access sequence information from the host device to the data storage device;
reading data from LBAs on the media that are identified by the LBA access sequence information;
storing the data read from LBAs on the media that are identified by the LBA access sequence information in a data fetch buffer in the data storage device;
communicating a read command from the host device to the data storage device that is directed to data stored at a media LBA identified by the LBA access sequence information after communicating the LBA access sequence information from the host device to the data storage device; and
responding to the read command by communicating the data associated with the read command from the data fetch buffer to the host device.

25. The method of claim 24, wherein defining a sequence of logical block addresses (LBAs) of data storage locations on the media in the data storage device from which the host device will read data comprises:
reading into the host device a file table from the data storage device that identifies on what media LBAs data is stored; and
generating by the host device based on the file table the LBA access sequence information that is communicated to the data storage device.

26. The method of claim 24, wherein storing the data read from LBAs on the media that are identified by the LBA access sequence information in the data fetch buffer in the data storage device comprises writing the read data into an integrated circuit memory in the data storage device.

27. The method of claim 24, wherein storing the data read from LBAs on the media that are identified by the LBA access sequence information in the data fetch buffer in the data storage device comprises writing the data onto a temporary storage location on the media.

28. The method of claim 27, wherein writing the read data onto a temporary storage location on the media comprises writing the data onto a contiguous group of LBAs at the temporary storage location on the media.
